(19) United States
(12) Patent Application Publication
(10) Pub. No.: US 2005/0210971 A1
(43) Pub. Date: Sep. 29, 2005

(54) Torque-detecting device

(75) Inventor: Tomohiro Satoh, Toyoake-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/089,457

(22) Filed: Mar. 25, 2005

(30) Foreign Application Priority Data
Mar. 26, 2004 (JP) 2004-092327

(51) Int. Cl. G01M 19/00

(52) U.S. Cl. 73/118.1

(57) ABSTRACT

A torque-detecting device includes a first member rotatable with a drive shaft of an engine generating torque; a second member rotatable in an identical rotational direction to one of the first member; an elastic member positioned between the first member and the second member, an elastic member which is elastically deformed in a rotational direction at a radially predetermined position between the first member and the second member so as to transmit torque, and so as to absorb torque vibrations that occur between the first member and the second member; a detecting unit for detecting a degree of load applied to the elastic member; and a calculating unit for calculating, on the basis of the degree of load detected by the detecting unit, a degree of torque transmitted from the first member to the second member.

### CROSS REFERENCE TO RELATED APPLICATIONS

This application is based on and claims priority under 35 U.S.C. §119 with respect to Japanese Patent Application 2004-092327, filed on Mar. 26, 2004, the entire content of which is incorporated herein by reference.

### FIELD OF THE INVENTION

This invention generally relates to a torque-detecting device capable of detecting a degree of torque outputted from an engine. More particularly, this invention pertains to a torque-detecting device, which is provided with a sensor that is not directly mounted on an output shaft of an engine, but rather positioned at a damper of a clutch assembly, and which can detect a degree of torque outputted from an engine with accuracy.

### BACKGROUND

Conventionally, in a torque-detecting device, by which a degree of torque inputted to a transmission, i.e., a degree of torque outputted from an engine, is detected, information on various conditions, such as an engine rotational speed (i.e., a rotational speed of a crankshaft), an opening degree of an accelerator pedal, a degree of output torque, and a level of an outside air temperature, is inputted. This type of torque-detecting device can access a degree of torque outputted from an engine, on the basis of a map that has been memorized in a memory storage of a computer, thereby enabling to obtain a degree of torque inputted to a transmission. In general, such a map can be a database in connection with information on a degree of outputted torque, information which is represented by measurement results of an experiment, or can be a computing equation in connection therewith.

As such a torque-detecting device, JP 08(1996)-278212A discloses an engine torque-detecting device which incorporates, therein, an intake air flow detecting means for detecting a flow amount Q of an air introduced into an engine; an engine rotational speed detecting means for detecting an engine rotational speed N; an engine torque calculating means for calculating a degree TQ of torque outputted from an engine in accordance with a formula TQ=K·^{Q}/N (K: constant); an intake air amount detecting means for detecting an amount of air introduced to an engine, by which it is possible to detect a condition of an engine filled with air; and a constant changing means for changing, on the basis of the detected amount of air introduced to an engine, the constant K in the aforementioned formula.

In this engine torque-detecting device, it is possible to detect a degree of torque outputted from an engine with good precision in detecting, and yet it does not have to be a magnetostrictive-type torque-detecting device, which costs highly. Moreover, in order to attain sufficient reduction in shift shock in a transmission, it is preferable that a degree of a line pressure for a transmission be modified in response to characteristics of torque outputted from an engine. In the aforementioned engine-torque detecting device, it is possible to shorten or abbreviate time needed for modifying a degree of a line pressure in response to engine torque characteristics, i.e., for matching a degree of a line pressure with engine torque characteristics, wherein sufficient reduction in shift shock in a transmission can be achieved.

However, in torque-detecting devices, by which a degree of torque outputted from an engine is assessed on the basis of a predetermined map, considerations should be preferably given to the followings.

First of all, data contained in a map are generated on the basis of the results obtained at a certain fixed condition, for example on a test vehicle. Namely, such data contained in a map have not been reflected with information in connection with parameters, such as a degree of actual acceleration and deceleration of a vehicle, an actual shift change and an actual opening degree of an accelerator pedal. In such circumstances, there may be a danger of difficulty in adjusting or cutting out an error between a torque estimated on the basis of the map and an actual torque. Because of such an error to be generated, it has been found in an automatic transmission, for example, an occurrence of unnecessary raise in an engine rotational speed and an occurrence of increase in a degree of shift shock.

Secondarily, when a vehicle is adapted in accordance with various conditions, such as characteristics of engine performance, a speed change ratio in a transmission and individual variability, in the view of an error between an estimated torque value and an actual torque value, there has no other choice but setting values for a vehicle on the safe side, rather than at an optimum compatible value.

Thirdly, commensurate with a recent trend of increase in the number of shift stages in a transmission, time needed for adapting a vehicle has increased.

Fourthly, still further consideration should be given to a matter that an output from an engine is reduced, which is caused due to change in characteristics with time.

The present invention has been made in view of the above circumstances, and provides a torque-detecting device, which is less expensive, and is capable of detecting a degree of torque generated by an engine with improved detecting precision. Moreover, the present invention provides a torque-detecting device, by which a vehicle can be adapted during a less period of time. Still moreover, the present invention provides a torque-detecting device, which is capable of detecting a degree of torque generated by an engine, regardless of an environment surrounding an engine and change in characteristics of an engine with time.

### SUMMARY OF THE INVENTION

According to an aspect of the present invention, a torque-detecting device includes a first member rotatable integrally with a drive shaft of an engine that generates torque; a second member rotatable in an identical rotational direction to one of the first member; at least one elastic member positioned between the first member and the second member, at least one elastic member which is elastically deformed in a substantially rotational direction at a radially predetermined position between the first member and the second member so as to transmit torque from the first member to the second member, and so as to absorb torque vibrations that occur between the first member and the second member; a detecting means for detecting a degree of load applied to the at least one elastic member; and a calculating means for calculating, on a basis of the degree of load detected by the detecting means, a degree of torque transmitted from the first member to the second member.

It is preferable that, when torque is transmitted from the first member to the second member, the detecting means detects, on a basis of a degree of elastic deformation of the at least one elastic member, a relative rotational displacement between the first member and the second member. On a basis of the relative rotational displacement between the first member and the second member detected by the detecting means, the calculating means calculates the degree of torque transmitted from the first member to the second member.

The first member can be attached with plural first projections projecting in a radial direction of the first member, while the second member can be attached with plural second projections projecting in a radial direction of the second member. In this case, the torque-detecting device preferably incorporate, therein, a first detecting means for detecting rotation of the plural first projections and oriented so as to face the plural first projections; and a second detecting means for detecting rotation of the plural second projections and oriented so as to face the plural second projections. On a basis of signals outputted by the first detecting means, and by the second detecting means, the detecting means detects a difference of a phase of the second member relative to a phase of the first member. The calculating means calculates, on a basis of the phase difference detected by the detecting means, the degree of torque transmitted from the first member to the second member.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross sectional view schematically illustrating a mechanical structure of a torque-detecting device according to a first embodiment of the present invention;

FIG. 2 is a block view schematically illustrating an operational circuit of the torque-detecting device according to the first embodiment of the present invention;

FIG. 3 is a cross sectional view schematically illustrating a mechanical structure of a torque-detecting device according to a second embodiment of the present invention;

FIG. 4 is a block view schematically illustrating an operational circuit of the torque-detecting device according to the second embodiment of the present invention; and

FIG. 5. is a block view schematically illustrating an operational circuit of the torque-detecting device according to a third embodiment of the present invention.

### DETAILED DESCRIPTION

Embodiments of the present invention will be described hereinbelow in detail with reference to the accompanying drawings. Certain terminology is used herein for convenience only and is not to be taken as a limitation on the invention. For example, words such as “upper”, “lower”, “left”, “right”, “horizontal”, “vertical”, “upward”, “downward”, “clockwise”, and “counter-clockwise” merely describe the configuration shown in the Figures.

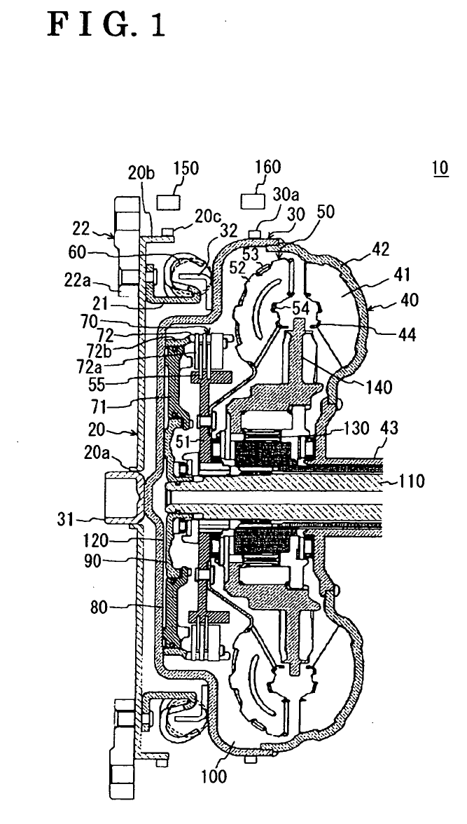

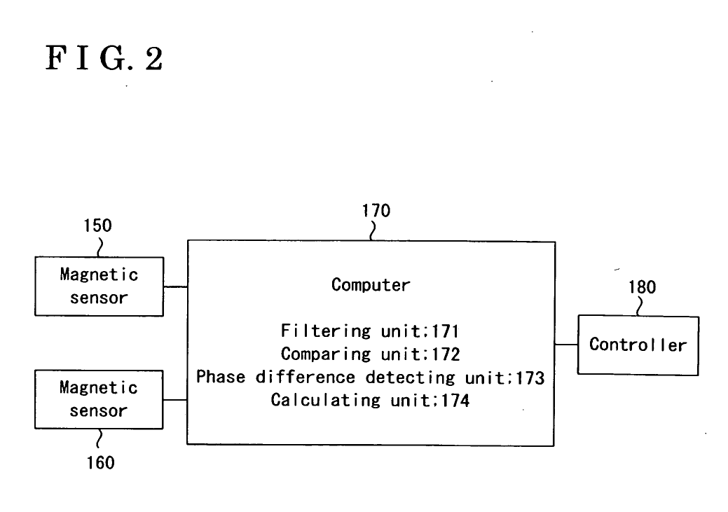

According to embodiments of the present invention, attention is focused on a damper portion of a torque converter of an automatic transmission disposed between an engine and a transmission, and a damper portion of a clutch assembly of a manual transmission. As is apparent from FIGS. 1 and 2, a torque-detecting device according to a first embodiment of the present invention is applied to, for example, a torque converter for an automatic transmission.

As is illustrated in FIG. 1, a torque converter assembly 10 incorporates, therein, a plate member 20 (i.e., a first member), a front cover 30 (i.e., a second member), a pump impeller 40, a turbine runner 50, dampers 60 (i.e., at least one elastic member), a lock-up clutch 70, an engagement oil pressure chamber 80, a front cover hub 90, an oil chamber 100, an oil passage 120, a one-way clutch 130, and a stator 140.

The plate member 20 is provided with a fitting bore 20a, into which a center piece 31 is fitted, in a manner such that the plate member 20 is mounted on an outer periphery of the center piece 31, and is rotatable relative to the center piece 31. The plate member 20 is further provided with an extending portion 20b, which extends from an outer periphery of the plate member 20 towards the front cover 30. Plural first projections 20c, each of which projects outwardly in a radial direction, are respectively attached to an outer peripheral surface of the extending portion 20b. A first magnetic sensor 150 (i.e., a first detecting means) is employed for the purpose of detecting rotation of the first projections 20c. According to the first embodiment of the present invention, the projections 20c are fixed to the extending portion 20b. Alternatively, the projections 20c can be fixed to a component that is rotatable integrally with the plate member 20. It is preferable that the component, to which the projections 20c can be fixed, be positioned at a side of an engine (not shown) as seen from the dampers 60, i.e., in the left side in FIG. 1, a component which is, for example, seat portions 21 or set blocks 22.

Each seat portion 21 serves as a seat for receiving one end of the damper 60, and, together with each set block 22, is riveted at a portion adjacent to the outer periphery of the plate member 20. Each seat portion 21 is attached to a surface of the plate member 20, a surface which faces the front cover 30, while each set block 22 is attached to the surface at the other side of the surface for each seat portion 21. Each set block 22 is configured with three plate type members of a substantially sector shape, three plate type members which are arranged on a circumference at identical intervals between each one of them. Each plate type member is built up of a pair of block portions 22a. To each set block 22, a drive plate (not shown) is bolted, which is operatively engaged with a pinion gear of a cell motor for an engine start-up. The plate member 20, the seat portions 21 and the set blocks 22 are rotated integrally with a drive shaft of an engine, i.e., with a crankshaft (not shown).

The front cover 30 is connected to an engine, via the set blocks 22, the plate member 20, the seat portions 21, the dampers 60 and the seat portions 32. The front cover 30 is securely welded to the center piece 31 in a manner such that the front cover 30 is positioned substantially coaxially with the crankshaft. The front cover 30 is formed to have a stepped portion that is defined outside a drum member 72b as viewed radially and at the side of the plate member 20 as seen from the turbine runner 50. Seat portions 32 are fixedly welded to a surface of the stepped portion positioned at the side of the plate member 20. Plural second projections 30a, each of which projects outwardly in a radial direction, are respectively attached to an outer peripheral surface of the front cover 30. A second magnetic sensor 160 (i.e., a second detecting means) is employed for the purpose of detecting rotation of the second projections 30a. According to the first embodiment of the present invention, the projections 30a are fixed to the front cover 30. Alternatively, the projections 30a can be fixed to a component that is rotatable integrally with the front cover 30. It is preferable that the component, to which the projections 30a can be fixed, is positioned at a side of a transmission (not shown) as seen from the dampers 60, i.e., at the right side in FIG. 1, the component which is, for example, the seat portions 32, an outer shell 42 or an impeller hub 43.

Each seat portion 32 serves as a seat for receiving the other end of the damper 60. At a surface of the front cover 30 on the other side of the surface facing the plate member 20, an approximately annular shaped front cover hub 90 makes contact with the front cover 30. This front cover hub 90 is secured to the front cover 30 at three welded portions on a circumference, three welded portions which are produced by means of projection welding from the interior.

The pump impeller 40 is coupled with the front cover 30 so as to be integral therewith. The pump impeller 40 includes the outer shell 42, in which a number of blades or fins 41 are implanted, and the impeller hub 43, which is welded to an inner periphery of the outer shell 42 so as to be integral therewith, and which is connected to a gear of an oil pump (not shown). The blades 41 are respectively integrated with inner cores 44 which are attached to inner edge sides of the blades 41.

The turbine runner 50 is oriented so as to face the pump impeller 40, and is connected to the input shaft 110 of a transmission (not shown) via a turbine hub 51. As described in the context of the pump impeller 40, the turbine runner 50 also includes an outer shell 53, in which a number of blades or fins 52 are implanted. The blades 52 are respectively integrated with inner cores 54 which are attached to inner edge sides of the blades 52. The outer shell 53 is bent and extends inwards as viewed radially, and is riveted to the turbine hub 51. The turbine hub 51 possesses inner peripheral splines that are engaged with outer peripheral splines of the input shaft 110, whereby the turbine hub 51 is connected to the input shaft 110. The turbine hub 51 supports plural frictional discs 55 at an outer peripheral end side thereof/at a radially outward end portion thereof. The plural frictional discs 55 are frictionally engaged with multiple frictional members 72a.

Each damper 60 includes an elastic member, such as a coil spring, that is positioned outside the lock-up clutch 70 as viewed radially and outside the front cover 30, i.e., at the left side of the front cover 30 in FIG. 1. The one end of each coil spring makes contact with the first seat portion 21, while the other end thereof makes contact with the second seat portion 32.

The lock-up clutch 70 serves as a mechanism for establishing, and interrupting, an engagement condition between the front cover 30 and the input shaft 110. The lock-up clutch 70 is positioned, as viewed axially, in the vicinity of a torus portion having the pump impeller 40 and the turbine runner 50, and is housed inside the front cover 30. The lock-up clutch 70 includes a piston 71 fitted by insertion into the engagement oil pressure chamber 80, and a clutch engagement portion 72 operated by the piston 71. The clutch engagement portion 72 includes both the multiple frictional members 72a, which are frictionally engaged with the frictional discs 55, and the drum member 72b which is welded to the front cover 30 and supports the frictional members 72a so as to make them frictionally rotate.

The engagement oil pressure chamber 80 is defined, as a separate unit, inside the oil chamber 100 surrounded with the front cover 30 and the pump impeller 40, and serves as an oil chamber to which oil for engaging the lock-up clutch 70 is supplied. The volume of the engagement oil pressure chamber 80 substantially corresponds to a volume surrounded with the front cover 30, the piston 71, the drum member 72b and the front cover hub 90.

The front cover hub 90 is positioned between the front cover 30 and the input shaft 110 (i.e., the turbine hub 51). An outer peripheral surface of the front cover hub 90 comes in contact with an inner peripheral surface of the piston 71, an inner peripheral surface which slidably moves in an axial direction of the input shaft 110. Although the front cover hub 90 is welded to the front cover 30 by means of projection-welding, a clearance between the front cover hub 90 and the front cover 30 serves as the oil passage 120.

The stator 140 stands between the pump impeller 40 and the turbine runner 50, and is supported by the one-way clutch 130.

The first magnetic sensor 150 detects, on the basis of rotation of the projections 20c, a rotational speed of the plate member 20. This first magnetic sensor 150 is mounted via an appropriate supporting member (not shown) in a manner such that the sensor 150 faces a surface where the projections 20c pass through in response to rotation of the plate member 20. Signals outputted from the first magnetic sensor 150 are inputted into a computer 170.

The second magnetic sensor 160 detects, on the basis of rotation of the projections 30a, a rotational speed of the front cover 30. This second magnetic sensor 160 is mounted via an appropriate supporting member (not shown) in a manner such that the sensor 160 faces a surface where the projections 30a pass through in response to rotation of the front cover 30. Signals outputted from the second magnetic sensor 160 are inputted into the computer 170.

The computer 170 processes signals outputted from the first magnetic sensor 150 and the second magnetic sensor 160, and detects a degree of torque outputted from an engine. The computer 170 incorporates, therein a filtering unit 171 (i.e., a filtering means), a comparing unit 172 (i.e., a comparing means), a phase difference-detecting unit 173 (i.e., a detecting means and a phase difference detecting means), and a calculating unit 174 (i.e., a calculating means). The filtering unit 171 acts so as to cut off or filter out noise components originating from engine activation, for example, effects due to fluctuations in rotation of a crankshaft, in a manner such that a crankshaft can be rotated appropriately. More specifically, the filtering unit 171 averages, by means of smoothing algorithm, signals outputted from the first magnetic sensor 150 at the plate member 20 side, and outputs a correction value A for correcting only a wide variation in frequency of signals. Likewise, the filtering unit 171 averages, by means of smoothing algorithm, signals outputted from the second magnetic sensor 160 at the front cover 30 side, and outputs a correction value B for correcting only a wide variation in frequency of signals. The comparing unit 172 compares the correction value A with the signals actually outputted from the magnetic sensor 150, and converts, on the basis of the correction value A as a threshold value, the actual signals to duty pulse signals A. Likewise, the comparing unit 172 compares the correction value B with the signals actually outputted from the magnetic sensor 160, and converts, on the basis of the correction value B as a threshold value, the actual signals to duty pulse signals B. The calculating unit 174 acts so as to calculate, on the basis of the phase difference detected by the phase difference-detecting unit 173, a degree of torque outputted from an engine. More specifically, in the calculating unit 174, the degree of torque outputted from an engine is obtained by summing torque subjected to the respective three dampers 60. The degree of torque subjected to each damper 60 is expressed by a formula: T=k·x·r. The calculated value “T” represents a degree of torque (N□m) outputted from an engine, a coefficient “k” represents a spring constant (N/m), a coefficient “x” represents a displacement amount of a spring, i.e., a compressed amount of a spring, and a coefficient “r” represents a radius of a spring, i.e., a spring position. The displacement amount of a spring substantially corresponds to a phase difference between the plate member 20 and the front cover 30.

Next, explained below is an operation of the torque-detecting device according to the first embodiment of the present invention.

When an engine (not shown) has been activated, i.e., has rotated, driving force from an engine is transmitted to a transmission via the plate member 20, the dampers 60 and the front cover 30. When a degree of torque outputted from an engine alters, displacement amounts of the dampers 60 vary. In such a case, a relative positional relationship between the plate member 20 and the front cover 30 is then changed. As described above, because a rotational displacement amount between the plate member 20 and the front cover 30, i.e., a degree of a phase difference therebetween, varies uniquely commensurate with a degree of torque transmitted, it is possible to estimate, on the basis of the phase difference, a degree of torque outputted from an engine with high detecting precision.

In view of the above, according to the first embodiment of the present invention, the first magnetic sensor 150 is mounted at a predetermined first position substantially facing the plural projections 20c of the plate member 20, while the second magnetic sensor 160 is mounted at a predetermined second position substantially facing the plural projections 30c of the front cover 30. Every time the respective projections 20c pass through a magnetic field immediately before the first magnetic sensor 150, the first magnetic sensor 150 produces electrical pulse signals in response to variation in magnetic flux. Likewise, every time the respective projections 30c pass through a magnetic field immediately before the second magnetic sensor 160, the second magnetic sensor 160 produces electrical pulse signals in response to variation in magnetic flux. The pulse signals outputted from the first magnetic sensor 150 form a first pulse waveform, while the pulse signals outputted from the second magnetic sensor 160 form a second pulse waveform. A distance between a point of the first pulse waveform and a point of the second pulse waveform, e.g., a distance between a peak of the first pulse waveform and a peak of the second pulse waveform, substantially corresponds to a degree of a phase difference, i.e., a degree of torque. The signals outputted from the first and second magnetic sensors are transmitted to the computer 170, and are processed so as to compute a degree of torque outputted from an engine. Information in connection with the computed degree of engine torque is fed to a controller 180 such as an ECU for engine activation and an ECU for transmission control.

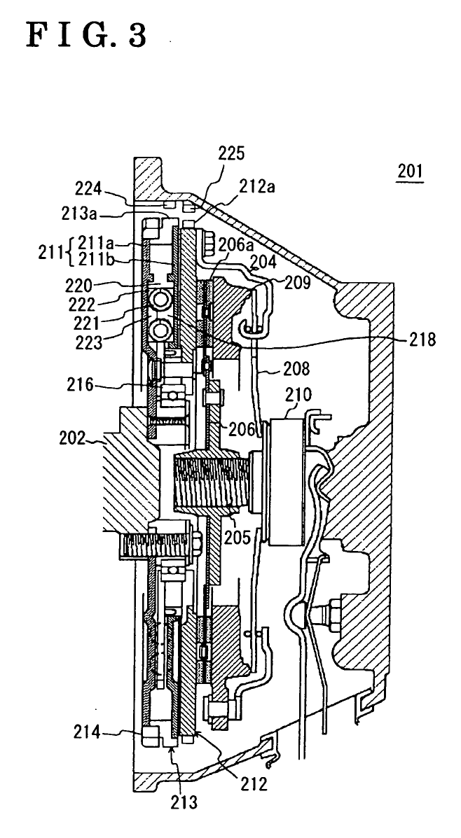

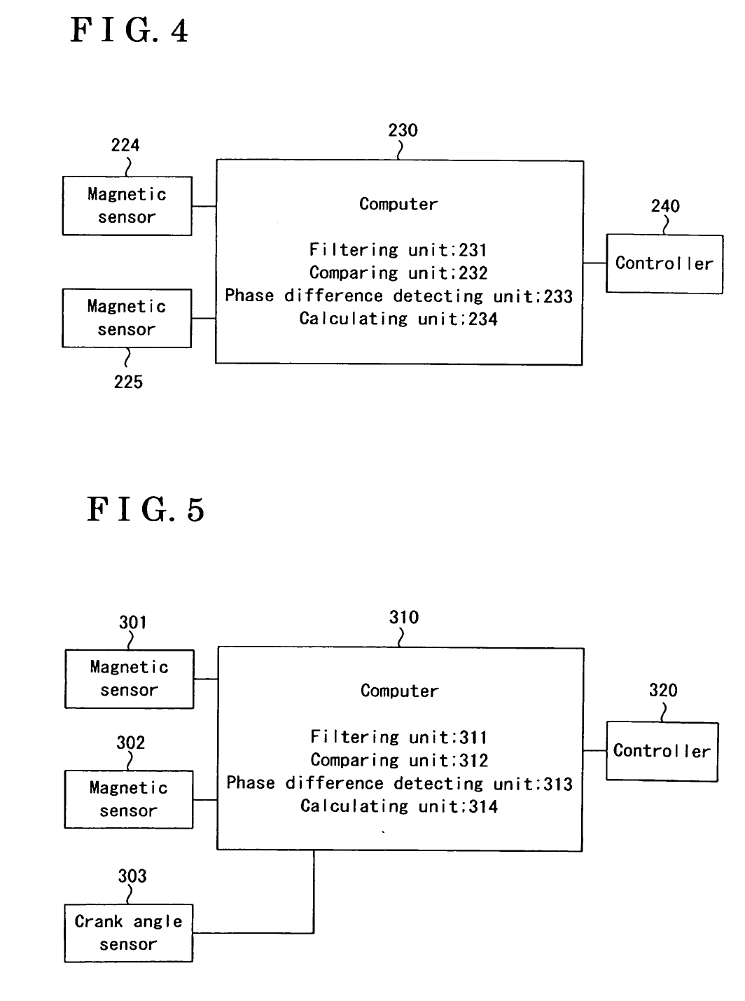

Next, described below is a torque-detecting device according to a second embodiment of the present invention, with reference to FIGS. 3 and 4. The torque-detecting device according to the second embodiment of the present invention is applied to, for example, a torque fluctuation-absorbing device for a manual transmission.

A torque fluctuation-absorbing device 201 is secured to a drive shaft 202 applied with a rotational torque that is a mechanical output from an engine (not shown). The torque fluctuation-absorbing device 201 incorporates, therein, a flywheel 212, a clutch cover 204 secured at one side of the flywheel 212, a clutch disc 206 fixed to one axial end of a driven shaft 205, frictional members 206a attached to the clutch disc 206, and a pressure plate 209 operated in response to a posture change of a diaphragm spring 208. When a release bearing 210, which can come in contact with the diaphragm spring 208, is moved in a direction of a transmission (not shown) side, i.e., in a right-side direction in FIG. 3, the diaphragm spring 208 applies pressure load to the pressure plate 209 in a manner such that the frictional members 206a can be frictionally engaged with the one side of the flywheel 212. On the other hand, when the release bearing 210 is moved in a direction of an engine (not shown) side, i.e., in a left-side direction in FIG. 3, in response to the posture change of the diaphragm spring 208, the frictional members 206a is interrupted from being frictionally engaged with the one side of the flywheel 212.

As an inertial mass, a drive plate 211 (i.e., a first member and a drive plate) and the flywheel 212 are included. The drive plate 211 is provided with a first drive plate 211a, which is fixedly engaged with a ring gear 214 at an outer peripheral surface thereof, and a second drive plate 211b, which is fixedly engaged with an outer ring gear 213 at an outer peripheral surface thereof. The first drive plate 211a and the second drive plate 211b hence establish an integral rotation. The second drive plate 211b faces the flywheel 212 at a certain distance therebetween.

The flywheel 212 is rotatably supported by the drive shaft 202 via a bearing 216 disposed at an inner peripheral end thereof. A ring gear 217 and a driven disc 218 (i.e., a second member and a driven plate) are respectively fixed to a portion in the vicinity of an inner periphery of the flywheel 212. The driven disc 218 lies between the first drive plate 211a and the second drive plate 211b. An oil seal 219 stands between the ring gear 217 and the second drive plate 211b. The driven disc 218 is provided with die-cut notches 220 at four portions circumferentially arranged. In each notch 220, there are three damper springs 221 disposed, each of which seats on a spring seat 222. Moreover, there is a separator 223 disposed between each one of the adjacent damper springs 221. When rotational torque of the drive plates 211a and 211b is transmitted to the damper springs 221, one end of the spring seat 222 positioned at a rotational direction of each damper spring 221 comes in contact with one end of the notch 220 of the driven disc 218, whereby each damper spring 221 absorbs torsional vibrations at the drive plate 211 side.

Plural first projections 213a, each of which projects outwardly in a radial direction, are respectively attached to an outer peripheral surface of the outer ring 213. A first magnetic sensor 224 (i.e., a first detecting means) is employed for the purpose of detecting rotation of the first projections 213a. According to the second embodiment of the present invention, the projections 213a are fixed to the outer ring 213. Alternatively, the projections 213a can be fixed to a component that is rotatable integrally with the outer ring 213. It is preferable that the component, to which the projections 213a can be fixed, be positioned at a side of an engine (not shown) as seen from the damper springs 221, i.e., in the left side in FIG. 3, the component which is, for example, the ring gear 214.

Plural second projections 212a, each of which projects outwardly in a radial direction, are respectively attached to an outer peripheral surface of the flywheel 212. A second magnetic sensor 225 (i.e., a second detecting means) is employed for the purpose of detecting rotation of the second projections 212a. According to the second embodiment of the present invention, the projections 212a are fixed to the flywheel 212. Alternatively, the projections 212a can be fixed to a component that is rotatable integrally with the flywheel 212. It is preferable that the component, to which the projections 212a can be fixed, is positioned at a side of a transmission (not shown) as seen from the damper springs 221, i.e., at the right side in FIG. 3, the component which is, for example, the clutch cover 204.

The first magnetic sensor 224 is mounted via an appropriate supporting member (not shown) in a manner such that the sensor 224 faces a surface where the projections 213a pass through in response to rotation of the outer ring 213. Signals outputted by the first magnetic sensor 224 are inputted into a computer 230.

The second magnetic sensor 225 is mounted via an appropriate supporting member (not shown) in a manner such that the sensor 225 faces a surface whether the projections 212a pass through in response to rotation of the flywheel 212. Signals outputted by the second magnetic sensor 225 are inputted into the computer 230.

The computer 230 processes signals outputted by the first magnetic sensor 224 and the second magnetic sensor 225. The computer 230 incorporates, therein a filtering unit 231 (i.e., a filtering means), a comparing unit 232 (i.e., a comparing means), a phase difference-detecting unit 233 (i.e., a detecting means and a phase difference detecting means), and a calculating unit 234 (i.e., a calculating means). The computer 230 can possess structures and functions, which both are identical to those of the computer 120 according to the first embodiment of the present invention.

Next, explained below is an operation of the torque-detecting device according to the second embodiment of the present invention.

When an engine (not shown) has been activated, i.e., has rotated, driving force from an engine is transmitted to a transmission via the drive plate 211, the damper springs 221, the driven disc 218, the flywheel 212, and the clutch disc 206. When a degree of torque outputted from an engine alters, displacement amounts of the damper springs 221 vary. In such a case, a relative positional relationship between the drive plate 211 and the flywheel 212 is then changed. As described above, because a rotational displacement amount between the drive plate 211 and the flywheel 212, i.e., a degree of a phase difference therebetween, varies uniquely commensurate with a degree of torque transmitted, it is possible to estimate, on the basis of the phase difference, a degree of torque outputted from an engine with high detecting precision.

In view of the above, according to the second embodiment of the present invention, the first magnetic sensor 224 is mounted at a predetermined first position substantially facing the plural projections 213a of the outer ring 213, while the second magnetic sensor 225 is mounted at a predetermined second position substantially facing the plural projections 212a of the flywheel 212. Every time the respective projections 213a pass through a magnetic field immediately before the first magnetic sensor 224, the first magnetic sensor 224 produces electrical pulse signals in response to variation in magnetic flux. Likewise, every time the respective projections 212a pass through a magnetic field immediately before the second magnetic sensor 225, the second magnetic sensor 225 produces electrical pulse signals in response to variation in magnetic flux. The pulse signals outputted by the first magnetic sensor 224 form a first pulse waveform, while the pulse signals outputted by the second magnetic sensor 225 form a second pulse waveform. A distance between a point of the first pulse waveform and a point of the second pulse waveform, e.g., a distance between a peak of the first pulse waveform and a peak of the second pulse waveform, substantially corresponds to a degree of a phase difference, i.e., a degree of torque. The signals outputted from the first and second magnetic sensors are transmitted to the computer 230, and are processed so as to compute a degree of torque outputted from an engine. Information in connection with the computed degree of engine torque is fed to a controller 240 such as an ECU for engine activation and an ECU for transmission control.

Next, described below is a torque-detecting device according to a third embodiment of the present invention, with reference to FIG. 5. The torque-detecting device according to the third embodiment of the present invention is different from those according to the first and second embodiments, in terms that the torque-detecting device according to the third embodiment incorporates, therein, a crank angle sensor for the purpose of cutting out or filtering out components originating from engine activation, for example, effects due to fluctuations in rotation of a crankshaft. However, apart from a crank angle sensor, structures and functions of the torque-detecting device according to the third embodiment are substantially the same as those according to the first and second embodiments.

The crank angle sensor 303 is employed for the purpose of detecting an angle of a crankshaft (not shown) of an engine. Signals outputted by the crank angle sensor 303 are inputted into a computer 310. Signals outputted by the crank angle sensor 303 act as synchronization signals for signals outputted by a first magnetic sensor 301 (i.e., a first detecting means) at a plate member side, and by a second magnetic sensor 302 (i.e., a second detecting means) at a front cover side. In the computer 310, a filtering unit 311 (i.e., a filtering means) implements synchronization on the basis of signals outputted by the crank angle sensor 303. More specifically, the filtering unit 311 outputs a correction value A which is generated by synchronizing signals outputted by the first magnetic sensor 301 with signals outputted by the crank angle sensor 303, and outputs a correction value B which is generated by synchronizing signals outputted by the second magnetic sensor 302 with signals outputted by the crank angle sensor 303. Operations of a comparing unit 312 (i.e., a comparing means), a phase difference-detecting unit 313 (i.e., a detecting means and a phase difference-detecting means), a calculating unit 314 (i.e., a calculating means) are the same as those according to the first embodiment, so that explanation thereof is omitted herein.

Next, described below is a torque-detecting device according to a fourth embodiment of the present invention.

According to the first and second embodiments of the present invention, phases of the first and second projections are detected by means of corresponding magnetic sensors. Alternatively, these magnetic sensors can be substituted by other type of sensors, such as known optical sensors, pulse sensors and so on.

Next, described below is a torque-detecting device according to a fifth embodiment of the present invention.

According to the first embodiment of the present invention, variation in load applied to the damper 60 is detected by use of the projections 20c, the projections 30a, the magnetic sensor 150 and the magnetic sensor 160. Alternatively, as substitute for those projections and magnetic sensors, a piezoelectric sensor can be positioned between the seat portion 21 and the seat portion 32 for each damper 60, thereby enabling to directly detect variation in load applied to the damper 60.

As described above, according to the embodiments of the present invention, by means of an elastic member (damper) positioned along with a torque converter and a clutch assembly, a degree of torque outputted by an engine can be detected on the basis of load applied to the elastic member. Therefore, it is possible to obtain at a low cost a degree of torque outputted by an engine, i.e., a degree of torque transmitted to a transmission.

Further, according to the embodiments of the present invention, a degree of torque outputted by an engine is detected on the basis of load applied to the elastic member (damper). Therefore, it is possible to obtain with high detecting precision a degree of torque outputted by an engine, regardless of an environment surrounding an engine and variation in characteristics of an engine with time.

Still further, according to the embodiments of the present invention, a degree of torque outputted by an engine is detected on the basis of load applied to the elastic member (damper). Therefore, this type of torque-detecting device is useful for a controller which needs to shorten or abbreviate a time needed for a shift schedule of an automatic transmission in which the number of shift stages are recently increased, which needs to control output from an engine, and which needs to estimate a degree of torque outputted from an engine.

The principles, the preferred embodiments and mode of operation of the present invention have been described in the foregoing specification. However, the invention, which is intended to be protected, is not to be construed as limited to the particular embodiment disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A torque-detecting device comprising:
a first member rotatable integrally with a drive shaft of an engine that generates torque;
a second member rotatable in an identical rotational direction to one of the first member;
at least one elastic member positioned between the first member and the second member, the at least one elastic member elastically deformed in a rotational direction at a radially predetermined position between the first member and the second member so as to transmit torque from the first member to the second member, and so as to absorb torque vibrations that occur between the first member and the second member;
a detecting means for detecting a degree of load applied to the at least one elastic member; and
a calculating means for calculating, on a basis of the degree of load detected by the detecting means, a degree of torque transmitted from the first member to the second member.

2. The torque-detecting device according to claim 1, wherein, when torque is transmitted from the first member to the second member, the detecting means detects, on a basis of a degree of elastic deformation of the at least one elastic member, a relative rotational displacement between the first member and the second member, and wherein, on a basis of the relative rotational displacement between the first member and the second member detected by the detecting means, the calculating means calculates the degree of torque transmitted from the first member to the second member.

3. The torque-detecting device according to claim 2 further comprising:
the first member attached with plural first projections projecting in a radial direction of the first member;
the second member attached with plural second projections projecting in a radial direction of the second member;
a first detecting means for detecting rotation of the plural first projections and oriented so as to face the plural first projections; and
a second detecting means for detecting rotation of the plural second projections and oriented so as to face the plural second projections,
wherein, on a basis of signals outputted by the first detecting means, and by the second detecting means, the detecting means detects a difference of a phase of the second member relative to a phase of the first member, and
wherein the calculating means calculates, on a basis of the phase difference detected by the detecting means, the degree of torque transmitted from the first member to the second member.

4. The torque-detecting device according to claim 3, wherein the first detecting means is a first magnetic sensor positioned at an outer peripheral side of the first member, the second detecting means is a second magnetic sensor positioned at an outer peripheral side of the second member, and wherein, on a basis of outputs from the first magnetic sensor and the second magnetic sensor, the detecting means detects the phase difference between the first member and the second member.

5. The torque-detecting device according to claim 4, wherein the detecting means detects a difference between phases in terms of a peak of a first wave outputted by the first magnetic sensor and a peak of a second wave outputted by the second magnetic sensor, and wherein, on a basis of the phase difference between the peaks detected by the detecting means, the calculating means calculates the degree of torque transmitted from the first member to the second member.

6. The torque-detecting device according to claim 1, wherein the first member is a plate member connected to a crankshaft of an engine, the second member is a front cover rotatable integrally with a pump impeller of a torque converter, and the at least one elastic member is a coil spring disposed between the plate member and the front cover.

7. The torque-detecting device according to claim 2, wherein the first member is a plate member connected to a crankshaft of an engine, the second member is a front cover rotatable integrally with a pump impeller of a torque converter, and the at least one elastic member is a coil spring disposed between the plate member and the front cover.

8. The torque-detecting device according to claim 3, wherein the first member is a plate member connected to a crankshaft of an engine, the second member is a front cover rotatable integrally with a pump impeller of a torque converter, and the at least one elastic member is a coil spring disposed between the plate member and the front cover.

9. The torque-detecting device according to claim 4, wherein the first member is a plate member connected to a crankshaft of an engine, the second member is a front cover rotatable integrally with a pump impeller of a torque converter, and the at least one elastic member is a coil spring disposed between the plate member and the front cover.

10. The torque-detecting device according to claim 5, wherein the first member is a plate member connected to a crankshaft of an engine, the second member is a front cover rotatable integrally with a pump impeller of a torque converter, and the at least one elastic member is a coil spring disposed between the plate member and the front cover.

11. The torque-detecting device according to claim 6, wherein the torque converter incorporates, therein, a lock-up clutch capable of establishing, and interrupting, an engagement between the front cover and an input shaft of a transmission.

12. The torque-detecting device according to claim 7, wherein the torque converter incorporates, therein, a lock-up clutch capable of establishing, and interrupting, an engagement between the front cover and an input shaft of a transmission.

13. The torque-detecting device according to claim 8, wherein the torque converter incorporates, therein, a lock-up clutch capable of establishing, and interrupting, an engagement between the front cover and an input shaft of a transmission.

14. The torque-detecting device according to claim 9, wherein the torque converter incorporates, therein, a lock-up clutch capable of establishing, and interrupting, an engagement between the front cover and an input shaft of a transmission.

15. The torque-detecting device according to claim 10, wherein the torque converter incorporates, therein, a lock-up clutch capable of establishing, and interrupting, an engagement between the front cover and an input shaft of a transmission.

16. The torque-detecting device according to claim 1, wherein the first member is a drive plate connected to a crankshaft of an engine, the second member is a driven plate rotatable integrally with a flywheel with which a clutch disc is frictionally engaged, and the at least one elastic member is a coil spring disposed between the drive plate and the driven plate.

17. The torque-detecting device according to claim 2, wherein the first member is a drive plate connected to a crankshaft of an engine, the second member is a driven plate rotatable integrally with a flywheel with which a clutch disc is frictionally engaged, and the at least one elastic member is a coil spring disposed between the drive plate and the driven plate.

18. The torque-detecting device according to claim 3, wherein the first member is a drive plate connected to a crankshaft of an engine, the second member is a driven plate rotatable integrally with a flywheel with which a clutch disc is frictionally engaged, and the at least one elastic member is a coil spring disposed between the drive plate and the driven plate.

19. The torque-detecting device according to claim 4, wherein the first member is a drive plate connected to a crankshaft of an engine, the second member is a driven plate rotatable integrally with a flywheel with which a clutch disc is frictionally engaged, and the at least one elastic member is a coil spring disposed between the drive plate and the driven plate.

20. The torque-detecting device according to claim 5, wherein the first member is a drive plate connected to a crankshaft of an engine, the second member is a driven plate rotatable integrally with a flywheel with which a clutch disc is frictionally engaged, and the at least one elastic member is a coil spring disposed between the drive plate and the driven plate.
